(19) United States
(12) Patent Application Publication
(10) Pub. No.: US 2005/0185421 A1
(43) Pub. Date: Aug. 25, 2005

(54) Light emitting panel assemblies

(75) Inventor: Takashi Hayakawa, Tokyo (JP)

Correspondence Address: YOUNG & THOMPSON, 745 SOUTH 23RD STREET, 2ND FLOOR, ARLINGTON, VA, 22202, US

(73) Assignee: MIYAKAWA CORPORATION, TOKYO (JP)

(21) Appl. No.: 10/831,141

(22) Filed: Apr. 26, 2004

(30) Foreign Application Priority Data
Feb. 19, 2004 (JP) 2004-043210

(51) Int. Cl. B60Q 1/00

(52) U.S. Cl. 362/612

(57) ABSTRACT

A light emitting panel assembly comprises a light emitting panel member having at least one light input area for receiving light from at least one light source. An air gap elimination area is provided to make the transmission of light from the light source to the light input area without any air gaps

### BACKGROUND OF THE INVENTION

The present invention relates generally to light emitting panel assemblies.

Light emitting panel assemblies are generally known. Different light emitting panel assembly configurations have been proposed to produce a desired light output distribution from the panel assemblies to fit an application as back lighting in liquid crystal display (LCD).

LCDs are widely used in personal communications equipment including, for example, mobile phone. The mobile phones require light emitting panels that provide for more efficient utilization of light. Light sources may be of any suitable type including, for example, a light emitting diode (LED) and a chip LED (a chip from an LED). The light sources are mechanically held in any suitable manner in order to impinge light rays to a light input surface of the panel assemblies. In particular, the light sources may be mechanically held in various manners known from JP2001-067917A, JP2001-067918A, JP2002-075038A, JP2002-197903A, and JP2002-229022A.

According to JP2001-067917A, a light emitting panel assembly includes a light emitting panel member often called “a light guide panel.” A light source is mechanically held in a slot formed in a back surface area of the light emitting panel member using a sufficient quantity of a suitable transparent embedding material.

According to JP2001-067918A, a light source has a distribution head mechanically held in a cavity formed in a light emitting panel member using a sufficient quantity of a suitable transparent embedding material.

According to JP2002-075038A, a plurality light sources, each in the form of a white LED, are spaced with varying intervals along the length of a light input surface on one edge of a light emitting panel member.

According to JP2002-197903A, a light source is held in a holder using a sufficient quantity of a suitable transparent resin. The holder mechanically holds a light source relative to an inclined light input surface of a light emitting panel member.

According to JP2002-229022A, a plurality of light sources, each in the form of a LED, are spaced along the length of a light input surface of a light emitting panel member and mechanically held in face to face relationship with respect to the light input surface.

In the field of mobile phones, preferably the light source for back lighting is a focused light source such as a chip LED. Such light source may be of any suitable type including, for example, a side emission chip LED mounted to a flexible printed circuit (FPC) or a printed circuit board (PCB), a top emission chip LED mounted to such FPC or PCB, and a bear chip die attached to such FPC or PCB by epoxy setting after subsequent wiring bonding. In either case, the light sources are positioned to direct the light rays from the light sources to the light input surface and mechanically held relative to the light emitting panel member.

For efficient utilization of light, any air gaps or air interfaces between the light sources and the light input surfaces should be eliminated to reduce light loss and to increase the light output emitted by the light emitting panel assemblies. Such air gaps or air interfaces are found to be derived from any unavoidable errors in each of various processes of assembling light sources and from any unavoidable errors in mounting the light sources. These problems are not addressed to in a satisfactory manner in the known light emitting panel assemblies.

However, the present invention relates to light emitting panel assemblies, which provide for more efficient utilization of light to suit a particular application. The present invention relates also to LCDs including such light emitting panel assembly as back lighting.

### SUMMARY OF THE INVENTION

According to one aspect of the present invention, there is provided a light emitting panel assembly comprising:
a light emitting panel member having at least one light input area for receiving light from at least one light source; and
an air gap elimination area provided to make the transmission of light from the light source to the light input area without any air gaps.

### BRIEF DESCRIPTION OF THE DRAWINGS

In the accompanying drawings:

FIG. 1 is a schematic exploded view showing a light emitting panel assembly configured to provide back lighting for a LCD panel;

FIG. 2 is an enlarged fragmentary view of a schematic cross section of the light emitting panel assembly taken through a plane vertical to and along the length of a light emitting surface of the panel assembly;

FIG. 3 is a schematic cross section showing a LCD apparatus in which the light emitting panel assembly provides back lighting for a LCD panel.

FIG. 4 is an enlarged fragmentary schematic plan view of another form of light emitting panel assembly;

FIG. 5 is an enlarged fragmentary schematic plan view similar to FIG. 4, showing another form of light emitting panel assembly; and

FIG. 6 is an enlarged fragmentary schematic plan view similar to FIG. 4, showing another form of light emitting panel assembly.

### DETAILED DESCRIPTION OF THE PREFERRED EMBODIMENTS

Referring now in detail to the drawings, and initially to FIG. 1, there is schematically shown one form of light emitting panel assembly 10 in accordance with the present invention. The light emitting panel assembly 10 includes a light emitting panel member 12, and one or more light sources 14, which emit light in a predetermined pattern in an air gap elimination member or area 16 used to eliminate air gaps between the light source 14 and the light emitting panel member 12. The air gap elimination area 16 is provided to make the transmission of light from the light source 14 to the light emitting panel member 12 without any air gaps. The light that is transmitted by the air gap elimination area 16 to the light emitting panel member 12 may be emitted along the entire length of the panel member 12 or from one or more light output areas along the length of the panel member 12 as desired to produce a desired light output distribution to fit a particular application.

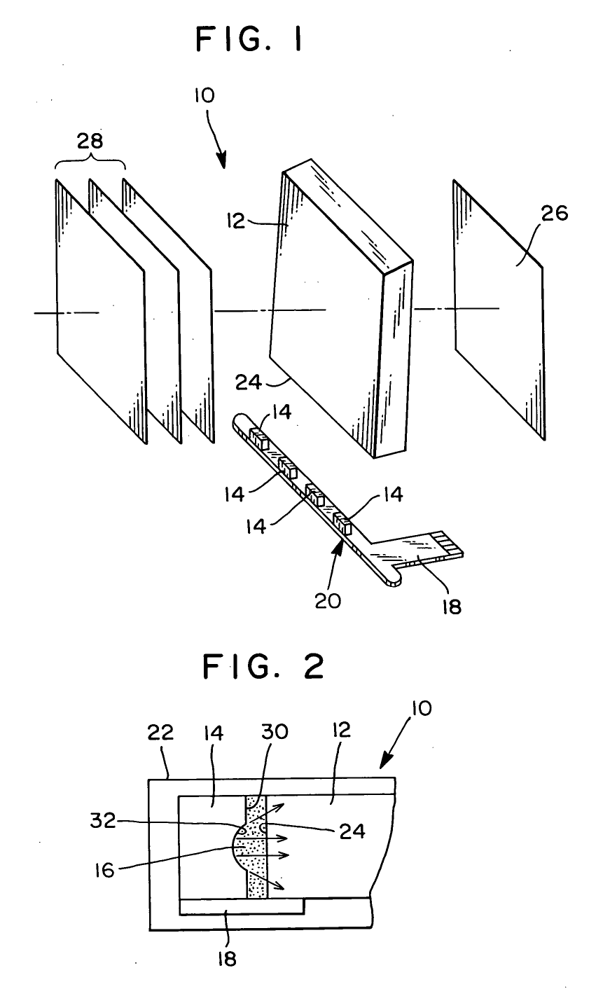

The light emitting panel assembly 10 shown in FIGS. 1 and 2 include four light sources 14, each in the form of LED. The LEDs 14 are mounted to a FPC 18 to make a light module 20. A holder 22 is used to mount the light module 20 such that the LEDs 14 are spaced along the length of a light input surface 24 at one end of the light emitting panel 12.

As seen in FIG. 1, a back reflector 26 may be attached or positioned against one side of the light emitting panel member 12 using an adhesive or other suitable method in order to improve light output efficiency of the light emitting panel assembly 10 by reflecting the light emitted from that side back through the panel member 12 for emission through the opposite side. Moreover, a transparent film, sheet or plate 28 may be attached or positioned against the side of the panel member 12 from which light is emitted using suitable method in order to produce a desired effect. For example, the member 28 may be a diffuser, a lens film or a colored film.

A transparent light emitting material of any type including, for example, acrylic or polycarbonate, may be used for the light emitting panel member 12.

A sufficient quantity of a resin may be used for the air gap elimination area 16 to bond the LEDs 14 to the light input surface 24 of the panel member 12. The resin may be a potting material. The potting needs to be carried out in order to eliminate any air gaps or air interface surfaces between the LEDs 14 and surrounding air gap elimination area 16 and between the air gap elimination area 16 and the light input surface 14 of the panel member 12. Moreover, creation of any air bubbles within the air gap elimination area 16 needs to be avoided. For example, such potting may be carried out under vacuum condition. Potting may be carried out using a dispenser or other method.

For example, the potting material may be an epoxy-based ultraviolet-curing resin or an acrylic-based ultraviolet-curing resin. The epoxy-based ultraviolet-curing resin includes, for example, ThreeBond 3121 UV-curing epoxy resin or ThreeBond 3130 UV-curing epoxy resin, both being products marketed by Three Bond Co. Ltd. The acrylic-based ultraviolet-curing resin includes, for example, ThreeBond 3042 UV-curing acrylic resin marketed by Three Bond Co. Ltd.

The potting material may preferably be chosen out of resins having expansion coefficient similar to expansion coefficient of the transparent light emitting material for the panel member 12. However, the potting material may be chosen out of resins having expansion coefficient different from the expansion coefficient of the transparent light emitting material for the panel member 12 in order to produce a desired diffusion effect at the light input surface 24. The potting material may be transparent or colored to fit a particular application.

In FIG. 2, the LEDs 14 have a light output side 30 formed with a light output recess 32. The potting material for the air gap elimination area 16 covers the entire surface areas of the light output side 30 and occupies the light output recess 32. It also covers the entire area of the light input surface 24 of the panel member 12. Accordingly, no air gaps exist in the path of transmission of light from each of the LEDs 14 to the light input surface 24 of the panel member 12.

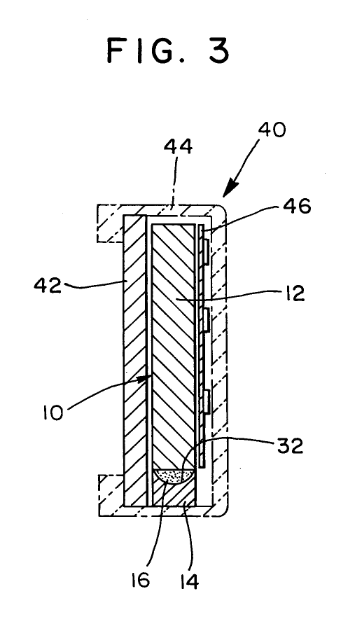

FIG. 3 illustrates a LCD apparatus 40 in which the light emitting panel assembly 10 provides back lighting for a LCD panel 42. The LCD panel 40 includes a case 44 and a driver substrate 46.

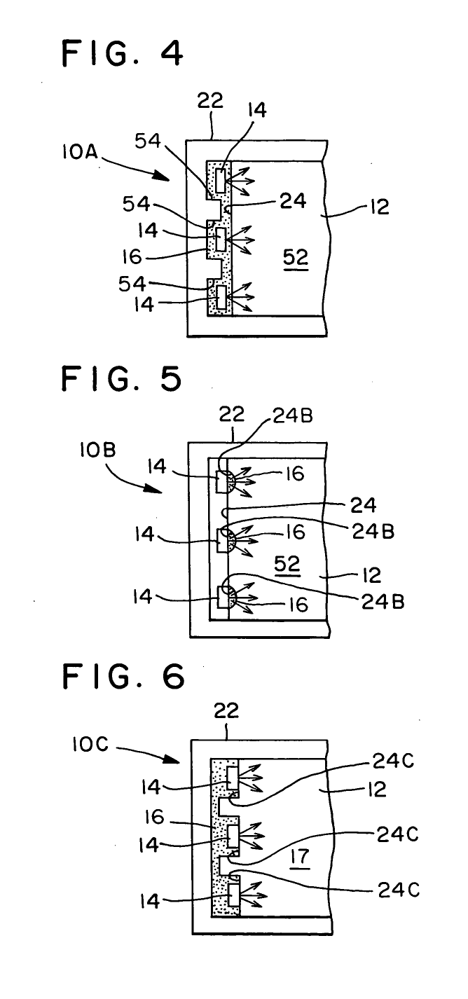

FIG. 4 is a schematic illustration of another form of light emitting panel assembly 10A in accordance with the present invention. The panel assembly 10A includes a light emitting panel member 12 having a light output area 52 and a light input surface 24, a holder 22 having three slots 54 receiving three light sources 14 in the form of LED, respectively, and an air gap elimination member or area 16. In FIG. 4, a potting material for the air gap elimination area 16 surrounds each LED 14 including a light output recess and covers the entire area of light input surface 24.

FIG. 5 is a schematic illustration of another form of light emitting panel assembly 10B in accordance with the present invention. The panel assembly 10B includes a light emitting panel member 12 having a light output area 52 and three light input cylindrical slots 24B covered by three light sources 14 in the form of LED, respectively, a holder 22, and an air gap elimination member or area 16. In FIG. 5, a potting material for the air gap elimination area 16 covers the light output side of each LED 14 and the cylindrical surface of one of the light input cylindrical slots 24B.

FIG. 6 is a schematic illustration of another form of light emitting panel assembly 10C in accordance with the present invention. The panel assembly 10C includes a light emitting panel member 12 having a light output area 52 and three light input rectangular slots 24C receiving three light sources 14 in the form of LED, respectively, a holder 22, and an air gap elimination member or area 16. In FIG. 6, a potting material for the air gap elimination area 16 surrounds each LED 14 except a light output side thereof and covers the inner surface of one of the light input rectangular slots 24C. It will be appreciated that the air gap elimination area 16 keeps the light output side of each LED 14 in firm interference engagement with a light input area of the light input rectangular slot 24C without any air gaps. Thus, the air gap elimination area 16 makes the transmission of light from the light output side of each LED 14 to the light input area of one of the light input rectangular slot 24C of the light emitting panel member 12 without any air gaps.

The light emitting panel assemblies 10, 10A, 10B and 10C are substantially the same except the features mentioned above in connection with FIGS. 4 to 6.

The light emitting panel assembly 10 in FIGS. 1 to 3 includes four light sources 14, whereas FIGS. 4 to 6 show another light emitting panel assemblies 10A, 10B and 10C, each including three light sources 14. Of course, it will be appreciated that the light emitting panel assemblies of the present invention may be provided with any number of light sources as desired, depending on the particular application.

Using the configuration shown in FIG. 4, a comparative test was conducted before and after potting material for the air gap elimination area 16. The panel member 12 was a 2.4 inch panel. Using a CCD camera, a quantity of light emitted from the entire surface of the panel member 12 was measured. Measurement was made at each of 307,200 points (=640×480) over the entirety of the light output area 52 and classified into one of 256 grades in brightness (0 to 255 grades), and integrated. The grade 0 indicates the lowest brightness, whereas the grade 255 is the highest brightness. The results were 54,793,856 before the potting, and 61,867,429 after the potting. The potting has enhanced the brightness by 12.9%.

The light emitting panel assemblies may be made such that the panel members are transparent without a back reflector. This allows the panel assemblies to be used for example to front lighting an LCD.

Although the present invention has been shown and described with respect to certain preferred embodiments, it is obvious that equivalent alterations and modifications will occur to those skilled in the art upon the reading and understanding of the specification. The present invention includes all such equivalent alterations and modifications, and is limited only by the scope of the claims.

1. A light emitting panel assembly comprising:
a light emitting panel member having at least one light input area for receiving light from at least one light source; and
an air gap elimination area provided to make the transmission of light from the light source to the light input area without any air gaps.

2. The light emitting panel assembly as claimed in claim 1, wherein the light source is a light emitting diode (LED) and the air gap elimination area is of a potting material potted to eliminate air gaps between the LED and light input area of the light emitting panel member.

3. The light emitting panel assembly as claimed in claim 2, wherein the LED has a light output recess, and the air gap elimination area occupies the light output recess.

4. The light emitting panel assembly as claimed in claim 2, wherein the LED has a light output recess, and the air gap elimination area surrounds the LED including the light output recess.

5. The light emitting panel assembly as claimed in claim 2, wherein the air gap elimination area covers the light input area of the panel member.

6. The light emitting panel assembly as claimed in claim 2, wherein the LED has a light output side, and the air gap elimination area surrounds the LED except the light output side.

7. A liquid crystal display (LCD) apparatus including the light emitting panel assembly as claimed in claim 2 for back lighting a LCD panel.

8. The LCD apparatus as claimed in claim 7, wherein the potting material for the air gap elimination area is of an epoxy-based ultraviolet-curing resin or an acrylic-based ultraviolet-curing resin.

9. The light emitting panel assembly as claimed in claim 2, wherein the potting material for the air gap elimination area is of an epoxy-based ultraviolet-curing resin or an acrylic-based ultraviolet-curing resin.
